(19) United States
(12) Patent Application Publication
(10) Pub. No.: US 2004/0158747 A1
(43) Pub. Date: Aug. 12, 2004

(54) Processor having high-speed control circuit and low-speed and low-power control circuit and method of using the same

(76) Inventor: Han-Jong Kim, Yongin-city (KR)

Correspondence Address: HARNESS, DICKEY & PIERCE, P.L.C., P.O. BOX 8910, RESTON, VA, 20195, US

(21) Appl. No.: 10/630,853

(22) Filed: Jul. 31, 2003

(30) Foreign Application Priority Data
Feb. 8, 2003 (KR) 2003-8009

(51) Int. Cl. G06F 1/30; G06F 1/28; G06F 1/26

(52) U.S. Cl. 713/300

(57) ABSTRACT

A processor may include a processor core and at least one peripheral device. A selecting circuit may be used for determining an operational state of the processor and for outputting a selection signal based on the evaluation. A high-speed control circuit may be used for controlling high-speed operations of at least one of the processor core and the peripheral device in response to the selection signal, and a low-speed and low-power control circuit may be used for controlling low-speed and low-power operations of at least one of the processor core and the peripheral device in response to the selection signal.

### CROSS REFERENCE TO RELATED APPLICATION

This application claims the priority of Korean Patent Application No. 2003-8009, filed on Feb. 8, 2003 in the Korean Intellectual Property Office, the disclosure of which is hereby incorporated by reference in its entirety.

### BACKGROUND OF THE INVENTION

1. Field of the Invention

The present generally relates to processors, and more particularly, to a processors having control circuitry implemented therewith.

2. Description of the Related Art

Various low-power modes have been introduced to extend the battery life of notebook computers, mobile telephones, or personal digital assistants (PDAs).

Processors used with notebook computers, mobile telephones, or PDAs may have predefined operational modes. These modes may include a normal mode, a slow (or sleep) mode, an idle mode, and a stop (or standby) mode. In certain modes, processor performance is curtailed and as a result, power consumption of the processor is reduced thereby an increase in battery life may be realized.

FIG. 1 illustrates a processor 100 according to the prior art. Hereinafter, the various operational modes of the processor 100 are described with reference to FIG. 1.

The processor 100 includes a processor core 120, such as a central processing unit (CPU), a peripheral device 130, and a controller 110.

In the normal mode, the processor core 120 and the peripheral device 130 may operate normally at a maximum (or full clock) speed. In the slow (or sleep) mode, the processor core 120 and the peripheral device 130 may operate at a lower speed than the maximum (or full clock) speed. In other words, in the slow (or sleep) mode, execution of a program stored in the processor core 120 may be temporally suspended, which potentially reduces current consumption of the processor 100.

In the idle mode, the controller 110 may prevent a clock signal CLK from being provided to the processor core 120. Therefore, in the idle mode, the processor core 120 does not consume power, or consumes very little power.

However, the controller 110 may still provide the clock signal CLK to the peripheral device 130 in the idle mode. Therefore, with the clock signal CLK supplied, the peripheral device 130 is capable of operating normally. The peripheral device 130 may include a wireless LAN card, a PC or PCMCIA card, or a liquid crystal display (LCD).

When the controller 110 receives an interrupt signal EXT_ITR from an external source, and the processor 100 is in the idle mode, the processor 100 may switch its operative state to either the normal or slow (or sleep) mode. In particular, the interrupt signal EXT_ITR activates the controller 110 such that it provides the clock signal CLK to the processor core 120.

In the stop (or standby) mode, the controller 110 may prevent the clock signal CLK from being provided to the processor core 120 or the peripheral device 130. As a result, current consumption of the processor 100 substantially reduced. That is current consumption is substantially limited to current leakage and current consumption by a power management circuit (not shown) of the controller 110.

In accordance with the above, processors used with notebook computers, mobile telephones, or PDAs typically have varying operational modes in order to control the overall amount of current draw in an on state. Controlling the overall amount of current draw may substantially reduce a total power consumption of a given device. Therefore, battery life may be improved.

### SUMMARY OF THE INVENTION

An exemplary embodiment of the present invention generally provides a processor which reduces power consumption of a high-speed processor.

According to one exemplary embodiment of the present invention, a processor having a processor core and at least one peripheral device, may include a selecting circuit for determining an operational state of the processor and for outputting a selection signal based on the evaluation, a high-speed control circuit for controlling high-speed operations of at least one of the processor core and the peripheral device in response to the selection signal, and a low-speed and low-power control circuit for controlling low-speed and low-power operations of at least one of the processor core and the peripheral device in response to the selection signal.

According to yet another exemplary embodiment of the present invention, a processor having a processor core and a peripheral device, may include a selecting circuit for evaluating an operation mode or operating frequency of the processor and for outputting a selection signal based on the evaluation, a high-speed control circuit for controlling respective high-speed operations of the processor core and the peripheral device, a low-speed and low-power control circuit for controlling respective low-speed and low-power operations of the processor core and the peripheral device, and a multiplexer for interfacing one of the high-speed control circuit with the processor core and the peripheral device and the low-speed and low-power control circuit with the processor core and the peripheral device.

According to yet another exemplary embodiment of the present invention a processor may include a circuit for selecting a control circuit from a plurality of control circuits, the control circuit for controlling one of at least a first device and a second device.

According to yet another exemplary embodiment of the present invention a method may include selecting a control circuit from a plurality of control circuits, and controlling at least a first device and a second device with the selected control circuit.

Further scope of applicability of the present invention will become apparent from the detailed description given hereinafter. However, it should be understood that the detailed description and specific examples, while indicating exemplary embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates a processor according to prior art.

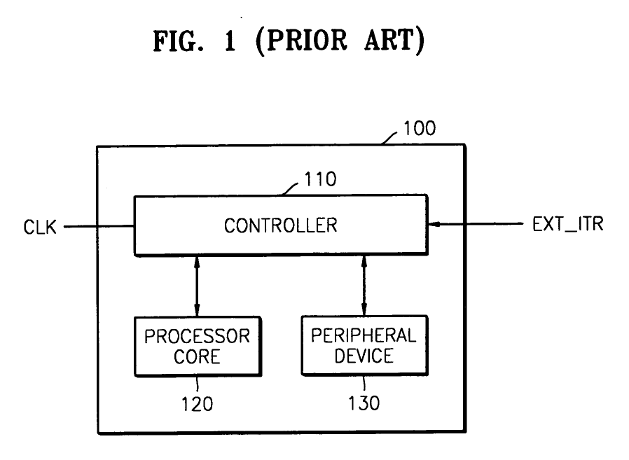

FIG. 2 illustrates a processor having a high-speed control circuit and a low-speed and low-power control circuit according to an exemplary embodiment of the present invention.

### DETAILED DESCRIPTION OF EXEMPLARY EMBODIMENTS

Exemplary embodiments of the present invention will now be described more fully with reference to the accompanying drawings. To facilitate understanding, the reference numerals have been used where possible, to designate similar elements that are common in the figures.

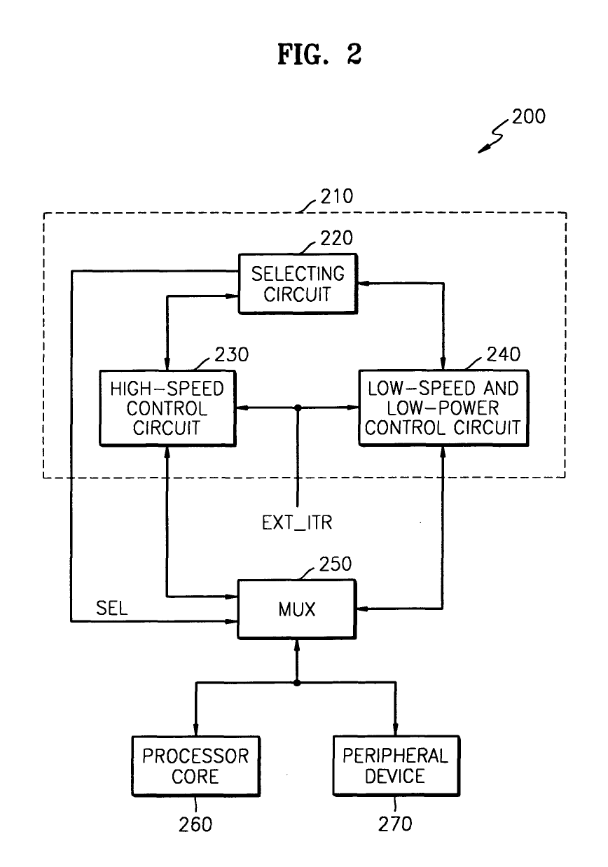

FIG. 2 illustrates a processor 200 having a high-speed control circuit 230 and a low-speed and low-power control circuit 240 according to an exemplary embodiment of the present invention.

Referring to FIG. 2, the processor 200 may include a control circuit 210, a multiplexer (hereinafter, referred to as a MUX) 250, a processor core 260, and a peripheral device 270.

The processor 200 may be used with, hand-held devices such as a mobile telephone and a personal digital assistant (PDA). However, the processor 200 may be used in other devices, as desired. For example, another such device may be a laptop computer, a tablet computer, or any suitable electronic device evaluation device.

According to an exemplary embodiment of the present invention, the processor core 260 may include applications executed within the processor 200. The applications may be user interfacable applications (i.e., a work processor, or the like), and/or machine related applications (i.e., operating system modules, or the like).

The control circuit 210 may include a selecting circuit 220, the high-speed control circuit 230, and the low-speed and low-power control circuit 240. Alternatively, the selecting circuit 220, the high-speed control circuit 230, and the low-speed and low-power control circuit 240, may be decentralized, yet interfaced together such that signal flow between the respective circuits is possible.

The selecting circuit 220 is capable of checking an operational mode or operating frequency of the processor 200. Based upon this checking or polling of the processor 200, a selection signal SEL may be output to the MUX 250. It is generally desirable to have power supplied to the selecting circuit 220 on a regular basis in order to ensure the checking or polling action is not interrupted, or undesirably suspended.

The operational modes of the processor 200 may generally include a normal mode and a slow mode. In the normal mode, the processor 200 may operate normally, which generally indicates that the processor core 260 and the peripheral device 270 operate at a normal operating frequency. In the slow mode, the processor 200 may operate at a low speed with low-power consumption, which generally indicates that the processor core 260 and the peripheral device 270 operate at a lower operating speed than that in the normal mode. Thus, power consumption of the processor 200 in the slow mode may be generally less than the power consumption of the processor 200 when it is operating in the normal mode.

The slow mode may include a sleep mode, an idle mode, a stop mode, and a standby mode. That is, the slow mode includes various operating modes other than the normal mode.

The selecting circuit 220 may monitor the state, or the current operation mode, of both the high-speed control circuit 230 and the low-speed and low-power control circuit 240. Based on the monitoring of the circuits 230 and 240, the selecting circuit may output the selection signal SEL to the MUX 250.

In response to the selection signal SEL, the MUX 250 may electrically connect the high-speed control circuit 230 with the processor core 260 and the peripheral device 270, or may electrically connect the low-speed and low-power control circuit 240 with the processor core 260 and the peripheral device 270.

Therefore, the high-speed control circuit 230 may control high-speed operations of the processor core 260 and the peripheral device 270 in the normal mode. Whereas, the low-speed and low-power control circuit 240 may control low-speed and low-power operations of the processor core 260 and the peripheral device 270 in the slow mode.

The high-speed control circuit 230 and the low-speed and low-power control circuit 240, respectively, may divide an input clock signal (not shown) and include a circuit (not shown) used to output the divided input clock signal to the processor core 260 and the peripheral device 270.

Power consumption of the processor core 260 and the peripheral device 270 under the control of the low-speed and low-power control circuit 240 may be less than power consumption of the processor core 260 and the peripheral device 270 under the control of the high-speed control circuit 230.

The processor core 260 may be a central processing unit (CPU) used in mobile telephones, PDAs, and computer systems generally, and the peripheral device 270 may include a wireless LAN card, a PC or PCMCIA card, and a liquid crystal display (LCD).

The selecting circuit 220 is capable of comparing the operating frequency of the processor 200 with a predetermined threshold frequency. Based upon this comparison, the selecting circuit may output the selection signal SEL to the MUX 250.

For instance, when the operating frequency of the processor 200 is higher than the predetermined threshold frequency, the selection signal SEL may be generated for selecting the high-speed control circuit 230 to control the high-speed operations of the processor core 260 and the peripheral device 270. Alternatively, when the operating frequency of the processor 200 is lower than the predetermined threshold frequency, the selection signal SEL may be generated for selecting the low-speed and low-power control circuit 240 to control the low-speed and low-power operations of the processor core 260 and the peripheral device 270.

An interrupt signal EXT_ITR may be used to convert from the slow mode to the normal mode, or from the normal mode to the slow mode. That is, the high-speed control circuit 230 and the low-speed and low-power control circuit 240 are capable of detecting a unique format of the interrupt signal EXT_ITR that is used to either place the high-speed control circuit 230 in an active state, or to place the low-speed and low-power control circuit 240 in an active state. In turn, the selecting circuit 220 may detect the operation states and/or the operating frequencies of the high-speed control circuit 230 and the low-speed and low-power control circuit 240, and thereby outputs the selection signal SEL based on the polling or detection to the MUX 250.

In one exemplary embodiment of the present, it may be desirable to have the low-speed and low-power control circuit 240 disabled and the high-speed control circuit 230 enabled. Thus, after application of the interrupt signal EXT_ITR to the circuits 230 and 240, the selecting circuit 220 determines the operational state of both the high-speed control circuit 230 and the low-speed and low-power control circuit 240, and may output the selection signal SEL to the MUX 250 instructing it to initiate control of the processor core 260 and the peripheral device 270 using the active high-speed control circuit 230.

Alternatively, according to another exemplary embodiment of the present invention, when the interrupt signal EXT_ITR is used to convert from the slow mode into the normal mode, the interrupt signal EXT_ITR is input into the low-speed and low-power control circuit 240 and the high-speed control circuit 230. Subsequently, the selecting circuit 220 determines a current state of the low-speed and low-power control circuit 240, enables the high-speed control circuit 230, and outputs the selection signal SEL to the MUX 250.

In yet another exemplary embodiment of the present invention, when the interrupt signal EXT_ITR is used to convert the normal mode into the slow mode, the interrupt signal EXT_ITR is input into the high-speed control circuit 230 and the low-speed and low-power control circuit 240. Subsequently, the selecting circuit 220 checks the operational modes and/or the operating frequencies of the high-speed control circuit 230 and the low-speed and low-power control circuit 240, selects the low-speed and low-power control circuit 240 and outputs the selection signal SEL based to the MUX 250.

Therefore, it may be preferable that the low-speed and low-power control circuit 240 is enabled and the high-speed control circuit 230 is disabled. Thus, the selecting circuit 220 determines the current state of each of the high-speed control circuit 230 and the low-speed and low-power control circuit 240, and outputs the selection signal SEL based on the determined results to the MUX 250.

Accordingly, in accordance with an exemplary embodiment of the present invention, the processor 200 may selectively use the high-speed control circuit 230 or the low-speed and low-power control circuit 240 to control the processor core 260 and the peripheral device 270.

As described above, the processor 200 according to an exemplary embodiment of the present invention selectively uses the low-speed control circuit to achieve reduction in power consumption.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A processor having a processor core and at least one peripheral device, comprising:
a selecting circuit for determining an operational state of the processor and for outputting a selection signal based on the evaluation;
a high-speed control circuit for controlling high-speed operations of at least one of the processor core and the peripheral device in response to the selection signal; and
a low-speed and low-power control circuit for controlling low-speed and low-power operations of at least one of the processor core and the peripheral device in response to the selection signal.

2. The processor of claim 1, wherein the high-speed control circuit controls the high-speed operations of one of at least the processor core and the peripheral device when the operational state determined is a normal mode, and the low-speed and low-power control circuit controls the low-speed and low-power operations of one of at least the processor core and the peripheral device when the operational state determined is a slow mode.

3. The processor of claim 1, wherein the selecting circuit compares the operating frequency of the processor with a predetermined threshold frequency and outputs the selection signal based on the compared result.

4. The processor of claim 3, wherein the high-speed control circuit controls the high-speed operations of one of at least the processor core and the peripheral device when the operating frequency of the processor is higher than the predetermined threshold frequency, and the low-speed and low-power control circuit controls the low-speed and low-power operations of one of at least the processor core and the peripheral device when the operating frequency of the processor is lower than the predetermined threshold frequency.

5. The processor of claim 1, wherein the processor core is a central processing unit (CPU).

6. The processor of claim 1, wherein the peripheral device is at least one of a wireless LAN card, a PC card, and a liquid crystal display (LCD).

7. A processor having a processor core and a peripheral device, comprising:
a selecting circuit for evaluating an operation mode or operating frequency of the processor and for outputting a selection signal based on the evaluation;
a high-speed control circuit for controlling respective high-speed operations of the processor core and the peripheral device;
a low-speed and low-power control circuit for controlling respective low-speed and low-power operations of the processor core and the peripheral device; and
a multiplexer for interfacing one of the high-speed control circuit with the processor core and the peripheral device and the low-speed and low-power control circuit with the processor core and the peripheral device.

8. The processor of claim 7, wherein the high-speed control circuit controls the high-speed operations of the processor core and the peripheral device when the operation mode is a normal mode, and the low-speed and low-power control circuit controls the low-speed and low-power operations of the processor core and the peripheral device when the operation mode is a slow mode.

9. The processor of claim 7, wherein the high-speed control circuit controls the high-speed operations of the processor core and the peripheral device when the operating frequency of the processor is higher than a predetermined threshold frequency, and the low-speed and low-power control circuit controls the low-speed and low-power operations of the processor core and the peripheral device when the operating frequency of the processor is lower than the predetermined threshold frequency.

10. A processor, comprising:
a circuit for selecting a control circuit from a plurality of control circuits, the control circuit for controlling one of at least a first device and a second device.

11. The processor of claim 10, further comprising an interface device for interfacing the selected control circuit with at least one of the first device and the second device.

12. The processor of claim 10, wherein the circuit for selecting compares an operating frequency of the processor to a threshold value in a process of selecting the control circuit from the plurality of control circuits.

13. The processor of claim 12, wherein the circuit for selecting selects a first control circuit of the plurality of control circuits when the operating frequency is higher than the threshold value.

14. The processor of claim 13, wherein the circuit for selecting selects a second control circuit of the plurality of control circuits when the operating frequency is lower than the threshold value.

15. The processor of claim 10, wherein the circuit for selecting evaluates a mode of the processor in a process of selecting the control circuit from the plurality of control circuits.

16. The processor of claim 15, wherein the circuit for selecting selects a first control circuit of the plurality of control circuits when the mode is a normal mode.

17. The processor of claim 15, wherein the circuit for selecting selects a second control circuit of the plurality of control circuits when the mode is a slow mode.

18. The processor of claim 15, wherein the plurality of control circuits includes at least a high-speed control circuit and a low-speed and low-power control circuit.

19. The processor of claim 15, wherein the first device is a processor core and the second device is a peripheral device.

20. A method, comprising:
selecting a control circuit from a plurality of control circuits; and
controlling at least a first device and a second device with the selected control circuit.
